(19) United States
(12) Patent Application Publication
(10) Pub. No.: US 2013/0231192 A1
(43) Pub. Date: Sep. 5, 2013

(54) APPARATUS, SYSTEMS AND METHODS FOR HANDHELD GAMING, INCLUDING INTERACTIVE MAPS

(71) Applicant: IGT, Reno, NV (US)

(72) Inventors: Jay S. Walker, Ridgefield, CT (US); James A. Jorasch, New York, NY (US); Stephen C. Tulley, Monroe, CT (US); Robert C. Tedesco, Fairfield, CT (US); Daniel E. Tedesco, Huntington, CT (US); Gregory Scribner, Southbury, CT (US); Jeffrey Y. Hayashida, San Francisco, CA (US)

(73) Assignee: IGT, Reno, NV (US)

(21) Appl. No.: 13/856,790

(22) Filed: Apr. 4, 2013

Related U.S. Application Data
(62) Division of application No. 12/516,843, filed on Jan. 20, 2010.
(60) Provisional application No. 60/868,432, filed on Dec. 4, 2006.

(51) Int. Cl. A63F 13/12

(52) U.S. Cl. CPC A63F 13/12
USPC 463/42

(57) ABSTRACT

A method comprises receiving a request for a location of at least one player of at least one gaming device from a handheld device, determining the location of the at least one player based upon gaming information derived from the at least one gaming device of the at least one player, and transmitting location information comprising the determined location of the at least one player to the handheld device.

### PRIORITY CLAIM

This application is a divisional of, and claims priority to and the benefit of, U.S. patent application Ser. No. 12/516,843, filed on Jan. 20, 2010, which is a national stage entry of, and claims priority to and the benefit of, PCT Application No. PCT/US2007/086366, filed on Dec. 4, 2007, which claims priority to and the benefit of U.S. Provisional Patent Application No. 60/868,432, filed on Dec. 4, 2006, now expired, the entire contents of each of which are incorporated herein by reference.

### FIELD OF THE INVENTION

The present disclosure relates to the display of location information and more particularly displaying interactive maps related to gaming activity on a display device.

### BRIEF DESCRIPTION OF THE DRAWINGS

FIG. 1 is an illustration of an exemplary and non-limiting embodiment of a system for practicing one or more embodiments described herein.

FIG. 2 is an illustration of an exemplary and non-limiting embodiment of a controller described herein.

FIG. 3 is a tabular representation of an exemplary and non-limiting embodiment of a player database described herein.

FIG. 4 is a tabular representation of another exemplary and non-limiting embodiment of a gaming activity database described herein.

FIG. 5 is a tabular representation of an exemplary and non-limiting embodiment of a geospatial database described herein.

FIG. 6 is an illustration of an exemplary and non-limiting embodiment of a gaming device described herein.

FIG. 7 is a flowchart of an exemplary and non-limiting embodiment described herein.

FIG. 8 is an illustration of an exemplary and non-limiting embodiment of a handheld device described herein.

FIG. 9A is an illustration of an exemplary and non-limiting embodiment of a display of a handheld device described herein.

FIG. 9B is an illustration of another exemplary and non-limiting embodiment of a display of a handheld device described herein.

FIG. 9C is an illustration of another exemplary and non-limiting embodiment of a display of a handheld device described herein.

FIG. 10 is a flowchart of an exemplary and non-limiting embodiment described herein.

### DETAILED DESCRIPTION

For many guests, the floor of a casino can be confusing and in some cases even intimidating. For instance, it is not uncommon for a casino to have as many as one thousand gaming devices such as slot machines, video poker, video keno, video blackjack and other games. Some casinos have far more than a thousand. For example, Foxwoods Resort and Casino (one of the largest in the world) boasts more than 7,200 slot machines. In addition to gaming machines, these casinos often have hundreds of table games, a plurality of restaurants and bars, entertainment venues such as theaters and concert halls, stores, and hotel rooms. Add thousands of people such as hotel guests, gamblers, dealers, pit crew, security personnel and other casino/hotel workers, and it can be very challenging to navigate through a busy casino, let alone find something or someone.

In accordance with exemplary embodiments disclosed herein, a system 100 and method are presented that are designed to aid the overwhelmed casino patron by providing access to an interactive mapping system operable on handheld devices 106 such as PDAs, portable gaming devices, cell phones, lap top computers, etc. Besides giving the user static information such as the location of restaurants, bars, gaming machines, table games, etc., the envisioned interactive handheld mapping utility also supplies dynamic information as well, For example, a player may be able to find out where his friends are, where to find a casino employee, which table games have open seats, or where the hottest or most popular gaming machines are. In some exemplary embodiments, the map is an application that is provided on a mobile gaming device 102 or another handheld device 106 such as a portable tablet computer that is provided by the casino. In yet other exemplary embodiments, the user may access the interactive mapping system using their cell phone, laptop, PDA, and the like.

The interactive mapping system 100 may use existing systems and/or networks capable of tracking the type of information offered on an interactive handheld map. For instance, a player may be found by contacting a mapping server, such as controller 200, that has access to information contained on the casino's player tracking system. If a player has used his player tracking card in a machine or gaming device 102, the controller 200 detects the use and records location information in a database. Similarly, if players are using a mobile gaming device 102, their position can be tracked using WiFi triangulation. Information collected from networked gaming devices 102 and tables may also be used.

Consider a scenario in which three friends make a trip to a casino together wherein each one of the friends wants to play a different game. Upon arrival, each friend picks up a handheld device 106 at the front desk and then goes to play their desired game. For example, one goes in search of an open blackjack table, another goes to the poker room, and the last to play slots. The slot player eventually gets bored and wants to meet up with one of his buddies, but he doesn't know where the blackjack or poker tables are located, and isn't positive that his friends are even still playing those games. Using the handheld device 106, he searches for his friend's player tracking card, and is shown the position of a video blackjack game where the friend used his card five minutes ago. Additionally, the handheld device 106 shows the user's position relative to the game, and provides directions on how to navigate the floor to get to his friend.

As described below in accordance with various exemplary and non-limiting embodiments, location information is requested by a handheld device 106 whereby a response to the request is determined, such as by a centralized server or controller 200, and transmitted for display upon the handheld device 106. While various exemplary and non-limiting embodiments described below illustrate requests for location information originating at a handheld device 106 and responses to such requests being transmitted to handheld devices 106, it is understood that in all such instances such requests may originate from, and responses thereto terminate at, another device in communication with controller 200 including, but not limited to, a gaming device 102.

In accordance with an exemplary and non-limiting embodiment, a method comprises receiving a request for a location of at least one player of at least one gaming device from a handheld device, determining the location of the at least one player based upon gaming information derived from the at least one gaming device of the at least one player, and transmitting location information comprising the determined location of the at least one player to the handheld device.

In accordance with another exemplary and non-limiting embodiment, a computer readable medium stores instructions configured to direct a processor to perform a method comprising receiving a request for a location of at least one player of at least one gaming device from a handheld device, determining the location of the at least one player based upon gaming information derived from the at least one gaming device of the at least one player, and transmitting location information comprising the determined location of the at least one player to the handheld device.

In accordance with another exemplary and non-limiting embodiment, an apparatus comprises a processor and a computer readable medium in communication with the processor and storing instructions configured to direct the processor to perform a method comprising receiving a request for a location of at least one player of at least one gaming device from a handheld device, determining the location of the at least one player based upon gaining information derived from the at least one gaming device of the at least one player, and transmitting location information comprising the determined location of the at least one player to the handheld device.

In accordance with an exemplary and non-limiting embodiment, a method comprises requesting a location of at least one player of at least one gaming device from a handheld device, receiving at the handheld device location information comprising the location of the at least one player, and displaying the location information on the handheld device.

In accordance with another exemplary and non-limiting embodiment, a computer readable medium stores instructions configured to direct a processor to perform a method comprising requesting a location of at least one player of at least one gaining device from a handheld device, receiving at the handheld device location information comprising the location of the at least one player, and displaying the location information on the handheld device.

In accordance with another exemplary and non-limiting embodiment, an apparatus comprises a processor and a computer readable medium in communication with the processor and storing instructions configured to direct the processor to perform a method comprising requesting a location of at least one player of at least one gaming device from a handheld device, receiving at the handheld device location information comprising the location of the at least one player, and displaying the location information on the handheld device.

In accordance with an exemplary and non-limiting embodiment, a method comprises receiving a request for a location of a gaming activity from a handheld device, determining at least one location of the gaming activity based upon gaming information, and transmitting location information comprising the at least one determined location of the gaming activity to the handheld device.

In accordance with another exemplary and non-limiting embodiment, a computer readable medium stores instructions configured to direct a processor to perform a method comprising receiving a request for a location of a gaming activity from a handheld device, determining at least one location of the gaming activity based upon gaming information, and transmitting location information comprising the at least one determined location of the gaming activity to the handheld device.

In accordance with another exemplary and non-limiting embodiment, an apparatus comprises a processor and a computer readable medium in communication with the processor and storing instructions configured to direct the processor to perform a method comprising receiving a request for a location of a gaming activity from a handheld device, determining at least one location of the gaming activity based upon gaming information, and transmitting location information comprising the at least one determined location of the gaming activity to the handheld device.

In accordance with an exemplary and non-limiting embodiment, a method comprises determining at least one of a product and a service based upon a gaming activity of a player, determining at least one location of the at least one of a product and service, and transmitting information comprising the determined at least one location of the at least one of a product and service to the player.

In accordance with another exemplary and non-limiting embodiment, a computer readable medium stores instructions configured to direct a processor to perform a method comprising determining at least one of a product and a service based upon a gaming activity of a player, determining at least one location of the at least one of a product and service, and transmitting information comprising the determined at least one location of the at least one of a product and service to the player.

In accordance with another exemplary and non-limiting embodiment, an apparatus comprises a processor and a computer readable medium in communication with the processor and storing instructions configured to direct the processor to perform a method comprising determining at least one of a product and a service based upon a gaming activity of a player, determining at least one location of the at least one of a product and service, and transmitting information comprising the determined at least one location of the at least one of a product and service to the player.

Numerous embodiments are described, and are presented for illustrative purposes only. The described embodiments are not intended to be limiting in any sense. These embodiments are described in sufficient detail to enable those skilled in the art to practice the invention, and it is to be understood that other embodiments may be utilized and that structural, logical, software, electrical and other changes may be made without departing from the scope of the invention. Accordingly, those skilled in the art will recognize that the invention may be practiced with various modifications and alterations. Although particular features may be described with reference to one or more particular embodiments or figures that form a part of the present disclosure, and in which are shown, by way of illustration, specific embodiments, it should be understood that such features are not limited to usage in the one or more particular embodiments or figures with reference to which they are described. The present disclosure is thus neither a literal description of all possible embodiments nor a listing of features that must be present in all embodiments.

The terms “an embodiment”, “embodiment”, “embodiments”, “the embodiment”, “the embodiments”, “an exemplary embodiment”, “some embodiments”, “an example embodiment”, “at least one embodiment”, “one or more embodiments” and “one embodiment” mean “one or more (but not necessarily all) embodiments of the invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary, a variety of optional components are described to illustrate the wide variety of possible embodiments described herein.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments described herein need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, an EEPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, GSM, COMA, EDGE and EVDO.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent example information only. Those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of embodiments described herein. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Reference will now be made in detail to various exemplary and non-limiting embodiments, some examples of which are illustrated in the accompanying drawings.

As used herein, “gaming device” refers to a device that is capable, at a minimum, of displaying gaming outcomes of a wagering game. Similarly, as used herein, a “wireless gaming device” refers to a gaming device 102 configured or otherwise adapted to engage in electronic communication via a wireless medium and attendant protocol. Examples of gaming devices 102 include, but are not limited to, slot machines, video poker machines, video blackjack machines, video keno machines, and casino table games (such as baccarat, blackjack and roulette) equipped with electronic components that may facilitate embodiments described herein (e.g., electronic virtual tables with simulated cards, chips and/or dealer; “smart” tables with a live dealer and one or more electronic devices such as chip/card readers, display screens and/or player/dealer input devices; etc.).

Furthermore, as used herein, “handheld device” refers to a portable device exhibiting the ability to process information and to communicate with a network and/or a central server via, for example, a WLAN such as a Wi-Fi connection operating on the IEEE 802.11 standard or GSM, While handheld device 106 may be configured to enable gaming activity, the operation of handheld device 106 need not enable any form of gaming. Handheld devices 106 may include input devices capable of receiving input from a user such as, for example, a touch screen, a keyboard/pad, a mouse, a push button, a microphone, a joystick, a directional pad, a trackball, a card reader and/or a bar code scanner. Handheld devices 106 may likewise include an output device such as, for example, a LCD, a LED, a CRT, Plasma Display Panels, electronic paper, a projection screen, and/or speakers.

As used herein, “player” refers to a person engaged, or who has the potential to engage in, a gaming activity and “user” refers to an operator of a device such as, for example, a handheld device 106. In addition, as used herein “requester” refers to a person or device requesting information such as, for example, via a handheld device 106. Depending on the context of the reference, these terms may be used interchangeably. For example, a “user” of a handheld device 106 may be engaged in a round of blackjack and may request location information regarding other players on the casino floor, In such an instance, the “user” is additionally a “player” and a requester”.

In accordance with an exemplary and non-limiting embodiment described more fully below, handheld devices 106 are utilized for the purpose of providing a user with an interactive handheld map. Besides having mapping capability, handheld devices 106 may also be used for a variety of casino related activities such as gambling. Examples of handheld devices 106 that may be utilized in non-limiting embodiments include, but are not limited to, (1) portable computing devices developed by Motion Computing, Inc. of Austin, Tex., such as the LS800 Tablet PC running Microsoft® Windows® XP Tablet PC Edition, and (2) portable computing devices developed by Hewlett-Packard Company of Palo Alt, Calif., such as the iPAQ hw6920 running Microsoft® Windows Mobile™ for Pocket PC. Those of ordinary skill in the art will appreciate that other (e.g., similar) devices may be programmed for utilization with respect to the exemplary embodiments described herein.

Yet other types of handheld devices 106 that may be used for the purposes of interactive mapping, in particular, casino mapping, may include a Cell Phone such as the Razr2 manufactured by Motorola, a PDA such as the Tungsten E2 Handheld manufactured by PALM, a Pocket PC such as the IPAQ Pocket PC manufactured by HP, Laptops, a portable video game device such as the PSP manufactured by Sony or other device such as a Game Boy, and a handheld GPS device with Wi-Fi capability such as the Traveler GPS 525+ manufactured by Pharos.

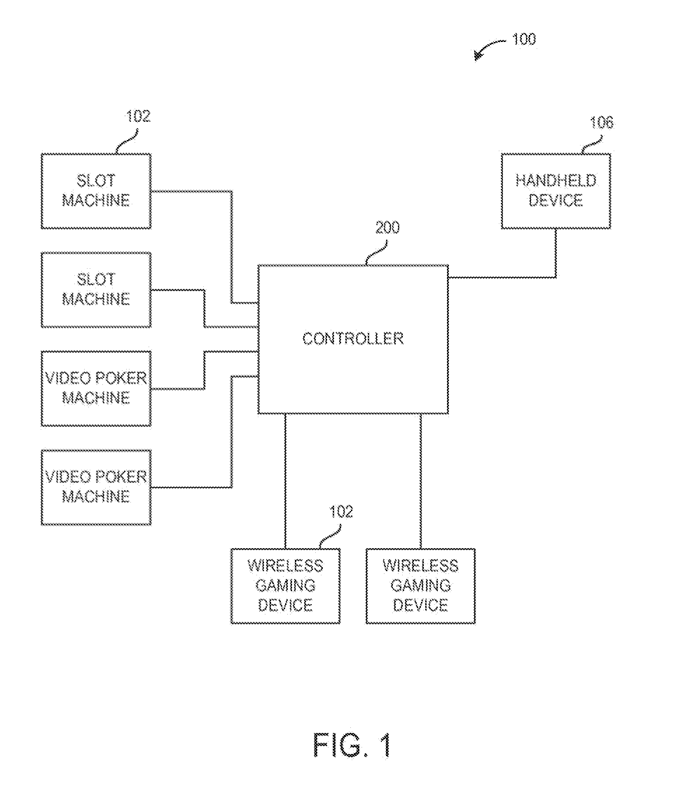

With reference to FIG. 1, there is illustrated a system 100 consistent with one or more exemplary and non-limiting embodiments having a controller 200 (e.g., a game server; a network server) in communication with one or more gaming devices 102 and with one or more handheld devices 106. As illustrated, system 100 is configured to work in a network environment including a controller 200 that is in communication, via a communications network, with one or more devices, such as gaming devices 102 (e.g., slot machines, video poker machines, table games (specifically those with the ability to communicate with controller 200, e.g., “smart gaming tables”, and table games connected to table/pit computers)) and handheld devices 106. The controller may communicate with the devices 102, 106 directly or indirectly, via a wired or wireless medium such as the Internet, LAN, WAN or Ethernet, Token Ring, or via any appropriate communications means or combination of communications means.

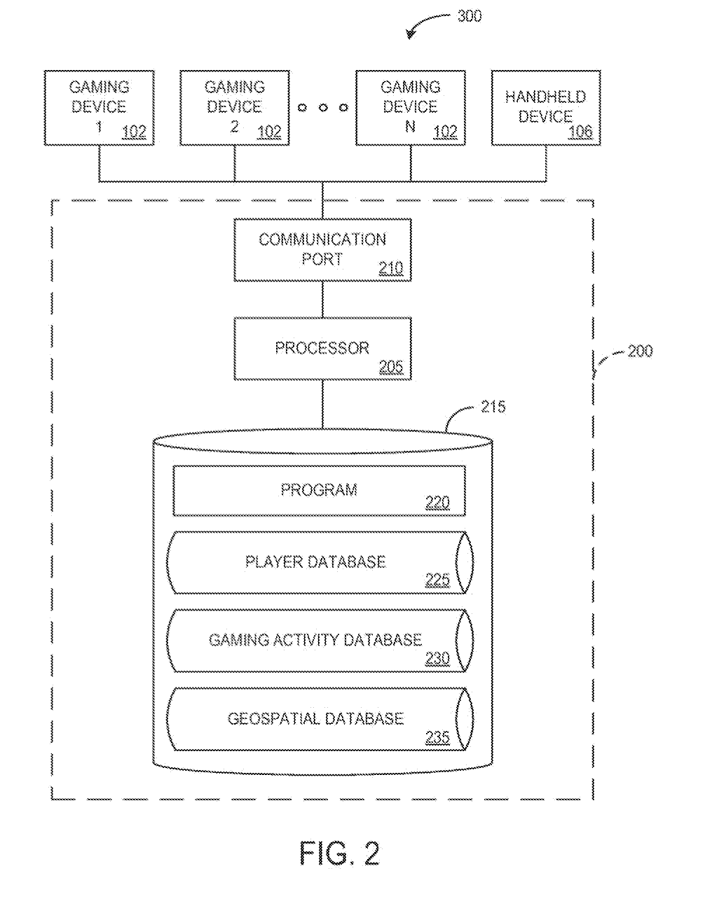

With reference to FIG. 2, there is illustrated in more detail an exemplary and non-limiting embodiment of a controller 200. As illustrated, controller 200 is operable to communicate with one or more gaming devices 102 and handheld devices 106. Although three gaming devices 102 and one handheld device 106 are illustrated, any number may be utilized in practice.

The controller 200 may be implemented as a system controller, a dedicated hardware circuit, an appropriately programmed general-purpose computer, or any other equivalent electronic, mechanical or electro-mechanical device. The controller 200 may comprise, for example, one or more server computers operable to communicate with one or more client devices, such as one or more gaming devices 102 and/or one or more handheld devices 106. The controller 200 may be operative to manage the system 100 and to execute some or all of the methods described herein.

In operation, the controller 200 may function under the control of a casino, another merchant, or other entity that may also control use of the gaming devices 102. For example, the controller 200 may be a slot server in a casino. In some embodiments, the controller 200 and a slot server may be different devices. In some embodiments, the controller 200 may comprise a plurality of computers operating together. In some embodiments, the controller 200 and a gaming device 102 may be the same device.

The controller 200 comprises a processor 205, such as one or more Intel® Pentium® processors. The processor 205 is in communication with a communication port 210 (e.g., for communicating with one or more other devices, such as one or more handheld devices 106) and a memory 215. The memory 215 may comprise an appropriate combination of magnetic, optical and/or semiconductor memory, and may include, for example, Random Access Memory (RAM), Read-Only Memory (ROM), a compact disc and/or a hard disk. The processor 205 and the memory 215 may each be, for example: (i) located entirely within a single computer or other device; or (ii) connected to each other by a remote communication medium, such as a serial port cable, telephone line or radio frequency transceiver. In one embodiment, the controller 200 may comprise one or more devices that are connected to a remote server computer for maintaining databases.

The memory 215 stores a program 220 for controlling the processor 205. The processor 205 performs instructions of the program 220, and thereby operates in accordance with the exemplary embodiments of methods described in detail herein. The program 220 may be stored in a compressed, uncompiled and/or encrypted format. The program 220 further includes program elements that may be necessary, such as an operating system, a database management system and “device drivers” for allowing the processor 205 to interface with computer peripheral devices. Appropriate program elements are known to those skilled in the art, and need not be described in detail herein. The program 220 may include computer program code that allows the controller 200 to employ the communication port 210 to communicate with, for example, a handheld device 106.

According to an exemplary embodiment, the instructions of the program 220 may be read into a main memory from another computer-readable medium, such as from a ROM to RAM. Execution of sequences of the instructions in program 220 causes processor 205 to perform the process steps described herein. In alternate exemplary embodiments, hard-wired circuitry may be used in place of, or in combination with, software instructions for implementation of the processes of the invention. Thus, exemplary embodiments are not limited to any specific combination of hardware and software.

The memory 215 may also store, for example, (i) a player database 225; (ii) a gaming activity database 230; and (iii) a geospatial database 235. Each of the databases 225 through 235 is described in more detail below.

In some exemplary embodiments (e.g., in an embodiment in which controller 200 manages downloadable games playable on one or more gaming devices 102), the memory 215 may store additional databases. Examples of such additional databases include, but are not limited to, (i) a game database that stores information regarding one or more games playable on and/or downloadable to one or more gaming devices 102, and (ii) a scheduling and/or configuration database useful for determining which games are to be made available on which gaming devices 102.

Although the databases 225 through 235 are described as being stored in a memory 215 of controller 200, in other embodiments some or all of these databases may be partially or wholly stored, in lieu of or in addition to being stored in a memory of controller 200, in a memory of one or more other devices. Such one or more other devices may comprise, for example, one or more peripheral devices, one or more gaming devices 102, one or more handheld devices 106, a slot server (if different from the controller 200), another device, or a combination thereof. Further, some or all of the data described as being stored in the memory 215 may be partially or wholly stored (in addition to or in lieu of being stored in the memory 215) in a memory of one or more other devices. Such one or more other devices may comprise, for example, one or more peripheral devices, one or more gaming devices 102, one or more handheld devices 106, a slot server Of different from controller 200), another device, or a combination thereof.

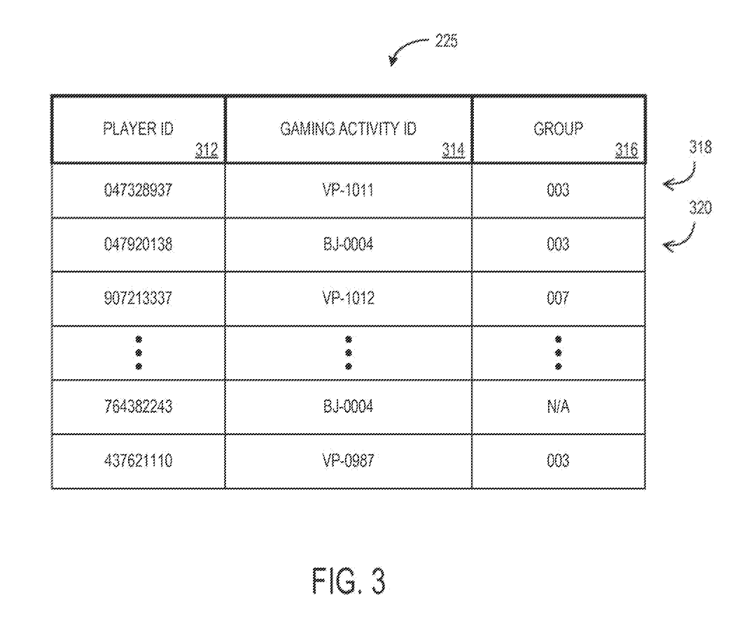

Various databases that may be useful in one or more embodiments will now be described. Example structures and sample contents of (i) a player database 225; (H) a gaming activity database 230; and (iii) geospatial database 235 are shown in FIGS. 3-5, respectively. The specific data and fields illustrated in these drawings represent only some embodiments of the records stored in the databases described herein. The data and fields of these databases can be readily modified, for example, to include more or fewer data fields. A single database also may be employed. Note that in the databases a different reference numeral is employed to identify each field of each database. However, in at least one embodiment, fields that are similarly named may store similar or the same data in a similar or in the same data format.

With reference to FIG. 3, there is illustrated in tabular form an exemplary and non-limiting embodiment of a player database 225. As illustrated, player database 225 has a player 10 column 312, a gaming activity id column 314, and a group column 316. For example, with reference to row 318, a player having a player id of “047328937” is engaged is a session of video poker at gaming device 102 “VP-1011”. It is further indicated that the player having player id “047328937” is related to two other players, having player ids “047920138” and “437621110”, via membership in predetermined group “003”. By way of further example, a player having a player id of “047920138” is engaged is a session of black jack at a gaming table having an id of “BJ-0004”. Other information may be stored in player database 225 as well such as a player's name, address, phone number, etc.

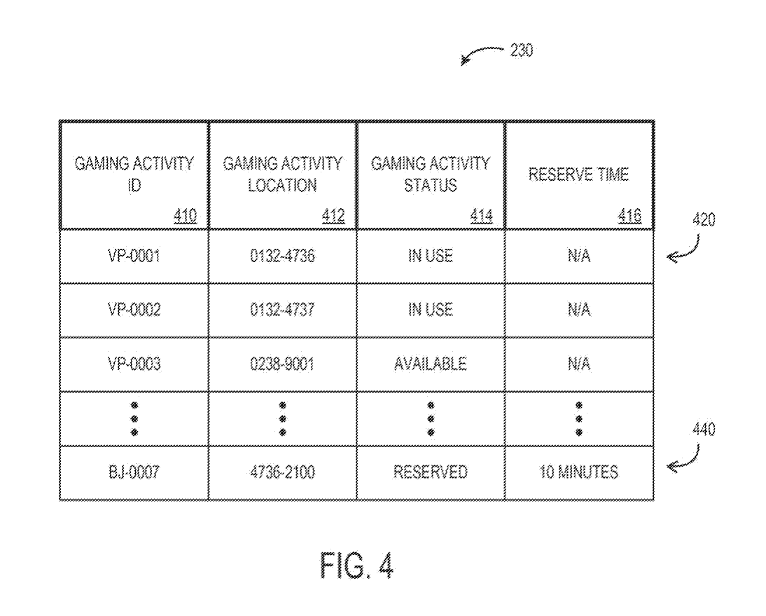

With reference to FIG. 4, there is represented, in tabular form, an exemplary and non-limiting embodiment of a gaming activity database 230 having multiple columns comprising at least a gaming activity id column 410, a gaming activity location column 412 in which is represented a location of the corresponding gaming activity, a gaming activity status column 414 in which is represented a current status of the gaming activity, and a reserve time column 416 that indicates a period of time during which the associated gaming activity id 410 is to be reserved. For example, with reference to row 420, it is evident that the gaming activity associated with gaming activity id 410 “VP-0001” is occurring at a video poker machine that is currently “In use”. Similarly, with reference to row 440, the gaming activity associated with gaming activity id 410 “BJ-0007” is occurring at a blackjack table that is “reserved” for a period of ten minutes. In addition, each gaming activity id 410 has an associated gaming activity location 412. Gaming activity location 412 may be formed of any data capable of being utilized, alone or in conjunction with additional accessed data, such as, for example, data retrieved from geospatial database 235, to define a location of the associated gaming activity id 410.

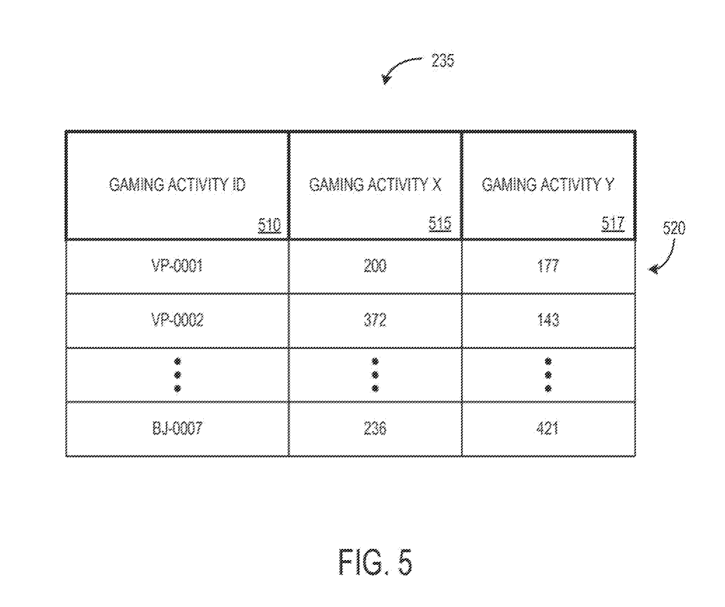

With reference to FIG. 5, there is represented, in tabular form, an exemplary and non-limiting embodiment of a geospatial database 235 having at least one column comprising gaming activity id 510 and columns 515 and 517 in which is represented X and Y coordinates, respectively, of an associated gaming activity id 510. While illustrated utilizing X and Y coordinates, geospatial database 235 may, in practice, adopt and incorporate any schema capable of storing geospatial data associated with each gaming activity having an associated gaming activity id 510. In addition, geospatial database 235 may store additional geospatial data including, but limited to, points, lines, areas, and associated text such as that required to produce a map of, for example, a casino floor plan.

In some exemplary and non-limiting embodiments (e.g., in an embodiment in which the controller 200 manages downloadable games playable on one or more gaming devices 102), the memory 215 may store additional databases. Examples of such additional databases include, but are not limited to, (i) a game database that stores information regarding one or more games playable on and/or downloadable to one or more gaming devices 102, and (ii) a scheduling and/or configuration database useful for determining which games are to be made available on which gaming device gaming devices 102 at what times. In other embodiments, some or all of these functions may be handled by a device distinct from controller 200.

Similarly, in one embodiment controller 200 may be operable to configure a handheld device 106 and a gaming device 102 (and/or another device, such as a kiosk, POS, COP, etc.) remotely, update software stored on a handheld device 106 and/or a gaming device 102 and/or to download software or software components to a handheld device 106 or gaming device 102. For example, controller 200 may be operable to apply a hot fix to software stored on a gaming device 102, modify a payout and/or probability table stored on a gaming device 102 and/or transmit a new version of software and/or a software component to a gaming device 102. The controller 200 may be programmed to perform any or all of the above functions based on, for example, an occurrence of an event (e.g., a scheduled event), receiving an indication from a qualified casino employee and/or other person (e.g., a regulator) and or receiving a request from a user of a handheld device 106. In other embodiments, some or all of these functions may be handled by a device distinct from controller 200.

The controller 200 may comprise, in at least some embodiments, an electronic device (e.g., a computer) that is operable to communicate with one or more gaming devices 102 and handheld devices 106. In some embodiments, controller 200 may function as a computer server and may control or direct at least some processes of gaming devices 102 and handheld devices 106. Alternately, or additionally, the controller 200 may contain or otherwise be configured to read data from and/or write data to one or more databases of one or more of the gaming devices 102 and handheld devices 106. Such data may comprise, for example, probability data, payout data, player data, and so on. In some embodiments, outcomes may be “centrally-determined” by controller 200 or another device that is distinct from the gaming devices 102. Such centrally-determined outcomes may then be promulgated to one or more gaming devices 102, such that they may be received by players.

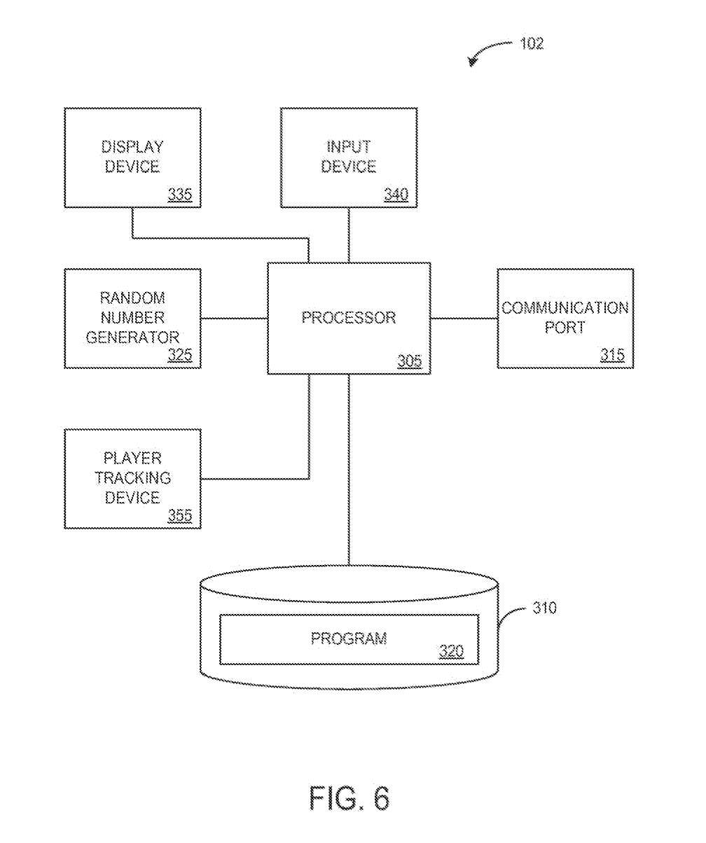

With reference to FIG. 6, there is illustrated in more detail an exemplary and non-limiting embodiment of a gaming device 102. The gaming device 102 may be implemented as a system controller, a dedicated hardware circuit, an appropriately programmed general-purpose computer, or any other equivalent electronic, mechanical or electro-mechanical device. The gaming device 102 may comprise, for example, a slot machine, a video poker terminal, a video blackjack terminal, a video keno terminal, a video lottery terminal, a pachinko machine or a table-top game. In various exemplary embodiments, a gaming device 102 may comprise, for example, a personal computer (e.g., which communicates with an online casino Web site), a telephone (e.g., to communicate with an automated sports book that provides gaming services), or a portable handheld gaming device 102 (e.g., a tablet computer, a personal digital assistant or Nintendo GameBoy). In some exemplary embodiments, the gaming device 102 may comprise a device operable to facilitate a table game (e.g., a device operable to monitor a blackjack game, such as size of a player's wager, cards received and/or decisions made). The gaming device 102 may comprise any or all of the gaming devices 102 of system 100 (FIG. 1). In some exemplary embodiments, a user device such as a PDA or cell phone may be used in place of, or in addition to, some or all of the gaming device 102 components depicted in FIG. 6.

Further, a gaming device 102 may comprise a personal computer or other device operable to communicate with an online casino and facilitate game play at the online casino. In one or more exemplary embodiments, the gaming device 102 may comprise a computing device operable to execute software that simulates play of a reeled slot machine game, video poker game, video blackjack game, video keno game, video roulette game, or lottery game.

The example gaming device 102 comprises a processor 305, such as one or more Inter® Pentium® processors. The processor 305 is in communication with a communication port 315 (e.g., for communicating with one or more other devices, such as with controller 200). The processor 305 may be, for example: (i) located entirely within a single computer or other device; or (ii) connected to each other by a remote communication medium, such as a serial port cable, telephone line or radio frequency transceiver.

A memory 310 stores a program 320 for controlling the processor 305. The processor 305 performs instructions of the program 320, and thereby operates in accordance with the invention, and particularly in accordance with the methods described in detail herein. The program 320, as well as any other program for controlling a processor described herein, may be stored in a compressed, uncompiled and/or encrypted format. The following description of program 320 applies equally to all programs for directing a processor described herein. The program 320 furthermore includes program elements that may be necessary, such as an operating system, a database management system and “device drivers” for allowing the processor 305 to interface with computer peripheral devices. Appropriate program elements are known to those skilled in the art, and need not be described in detail herein.

According to an embodiment, the instructions of the program 320 may be read into a main memory from another computer-readable medium, such as from a ROM to RAM. Execution of sequences of the instructions in program 320 may cause processor 305 to perform one or more process steps described herein. In alternate embodiments, hard-wired circuitry may be used in place of, or in combination with, software instructions for implementation of the processes of the invention. Thus, embodiments described herein are not limited to any specific combination of hardware and software.

The memory 310 may also store one or more databases. For example, memory 310 may store one or more of a probability database (not shown) and a payout database (not shown).

The fields of a probability database may specify, for example: (i) a random number (or range of random numbers) that may be generated by a random number generator; and (ii) an outcome that indicates the one or more indicia comprising the outcome that corresponds to the random number of a particular record. A gaming device 102 may utilize a probability database to determine, for example, what outcome corresponds to a random number generated by a random number generator and to display the determined outcome. The outcomes may comprise the three symbols to be displayed along the payline of a three-reel slot machine. Other arrangements of probability databases are possible. For example, the book “Winning At Slot Machines” by Jim Regan (Carol Publishing Group Edition, 1997) illustrates examples of payout and probability tables and how they may be derived. The entirety of this book is incorporated by reference herein for all purposes.

The fields of a payout database may specify, for example; (i) an outcome, which indicates the one or more indicia comprising a given outcome; and (ii) a payout that corresponds to each respective outcome. If gaming device 102 comprises a three-reel slot machine, for example, the outcomes may be those obtained on a three-reel slot machine.

A gaming device 102 may utilize a payout database to determine whether a payout should be output to a player as a result of an outcome obtained for a game. For example, after determining the outcome to output on the gaming device 102, the gaming device 102 may access the payout database to determine whether the outcome for output is one of the outcomes stored as corresponding to a payout. If it is, the gaming device 102 may provide the corresponding payout to the player via a benefit output device described herein. Other arrangements of payout databases are possible. For example, the book “Winning At Slot Machines” by Jim Regan (Carol Publishing Group Edition, 1997), previously incorporated by reference, illustrates many examples of payout and probability tables and how they may be derived.

In one or more exemplary embodiments, as described, data may be stored in a memory of another device (e.g., a database of controller 200 or a database of another server device). In one or more exemplary embodiments, gaming device 102 may be operable to access the data thereof or have information associated with the data stored therein downloaded to the gaming device 102 as necessary and/or appropriate.

The processor 305 is also operable to communicate with a random number generator 325, which may be a component of gaming device 102. The random number generator 325 (as well as any other random number generator described herein), in accordance with at least one exemplary embodiment, may generate data representing random or pseudo-random values (referred to as “random numbers” herein).

The display device 335 may comprise, for example, one or more distinct display areas and/or one or more distinct display devices 335. For example, one of the display areas may display outcomes of games played on the gaming device (e.g., electronic reels of a gaming device). Another of the display areas may display rules for playing a game of the gaming device 102. Yet another of the display areas may display the benefits obtainable by playing a game of the gaming device 102.

As described more fully below with reference to various exemplary and non-limiting embodiments, the display device may be used to provide location information. For example, a display device 335 of a slot machine (or other gaming device 102) may be used to display location information (e.g., a player cashes out and, before leaving slot machine, pulls up a map of where his friend is located).

The processor 305 is also in communication with an input device 340, which is a device that is capable of receiving an input (e.g., from a player or another device) and which may be a component of gaming device 102. An input device may communicate with or be part of another device (e.g. a controller 200, a gaming device 102, etc.). Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFD) receiver, an RF receiver, a thermometer, a pressure sensor, an infrared port (e.g., for receiving communications from a second gaming device or another device such as a smart card or PDA of a player), and a weight scale. For gaming devices 102, common input devices include a button or touch screen on a video poker machine, a lever or handle connected to the gaming device, a magnetic stripe reader to read a player tracking card inserted into a gaming device, a touch screen for input of player selections during game play, and a coin and bill acceptor. Input device 340 may comprise any of the above-described input devices or any combination thereof (i.e., input device 340 may comprise more than one input device).

In some exemplary embodiments, a gaming device 102 may comprise components capable of facilitating both input and output functions (i.e., input/output devices). In one example, a touch-sensitive display screen comprises an input/output device (e.g., the device outputs graphics and receives selections from players).

Of course, as would be understood by one of ordinary skill in the art, a gaming device 102 may comprise various combinations of any or all of the component devices described herein. For example, in one or more embodiments, the gaming device may include more than one display device 335, one or more other output devices, several input devices 340, and so on (e.g., two display screens, two audio speakers, a headset, a ticket-in/ticket-out device and several buttons).

In one exemplary embodiment, the player tracking device 355 may comprise (i) a card reader (e.g., a port into which player tracking cards may be inserted), (ii) various input devices (e.g., a keypad, a touch-screen), (iii) various output devices (e.g., a small, full-color display screen), and/or (iv) combinations thereof (e.g., a touch-sensitive display screen that accommodates both input and output functions). Various commercially available devices may be suitable for such an application, such as the NextGen™ interactive player tracking panel manufactured by IGT™ or the iVIEW™ display screen manufactured by Bally® Gaming and Systems.

In a specific example, a gaming device may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. Forms of memory 310 that may be found in a gaming device 102 include, but are not limited to, electronically erasable programmable read-only memory (EEPROM), erasable programmable read-only memory (EPROM) and flash memory. Thus, in one or more embodiments, an EPROM storing software with instructions for carrying out aspects of the various embodiments (as well as instructions for carrying out other functions traditionally performed by the gaming device 102) may replace an EPROM previously installed in a gaming device or may be reprogrammed in accordance with one or more embodiments described herein, such that the gaming device 102 may be configured to operate in accordance with various processes described herein.

In exemplary and non-limiting embodiment, the display device 335 and input device 340 may operate, together or separately, as a player interface. A player interface may comprise, for example, a video screen that is a touch screen operable to display such one or more such menus on the display device 335.

It should be appreciated that one or more embodiments may include storing graphic and/or sound elements that are used to construct the menu of available options. These elements may be stored, for example, in EEPROM, flash memory, hard disk, CD ROM, or in any other suitable storage device. The menu may be displayed via any suitable display device 335, such as a CRT, LCD, VFC, LED display. In one embodiment, the menu may be implemented using only dedicated electromechanical switches. In one embodiment, a player operates an input device 340 of the gaming device 102 operable to display the menu, in order to cause the menu to be displayed. In one embodiment, the device includes a touch screen and a touch screen controller (not shown) associated with a video monitor display device 335. The touch screen and touch screen controller may be operable to communicate with a video controller of the video monitor display device and a processor (e.g., a processor of gaming device 102). Thus, a player may be enabled to indicate decisions by touching the touch screen in the appropriate places.

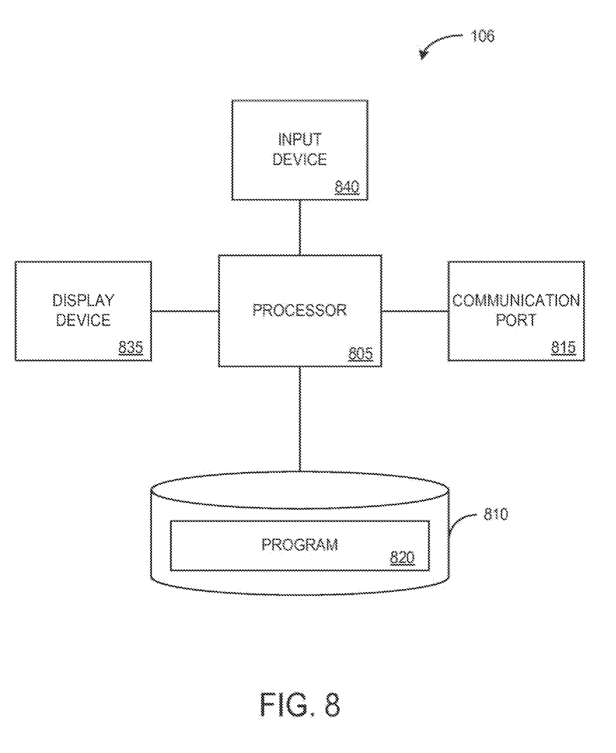

With reference to FIG. 8, there is illustrated in more detail an exemplary and non-limiting embodiment of a handheld device 106. The handheld device 106 may comprise a personal computer or other device operable to communicate with an online casino and facilitate game play at the online casino. In one or more exemplary embodiments, the handheld device 106 may comprise a computing device operable to execute software that enables gaming activity, facilitates the request of location information, or enables the display of location information.

The example gaming device 106 comprises a processor 805, such as one or more Intel® Pentium® processors. The processor 805 is in communication with a communication port 815 (e.g., for communicating with one or more other devices, such as with controller 200). The processor 805 may be, for example: (i) located entirely within a single computer or other device; or (ii) connected to each other by a remote communication medium, such as a serial port cable, telephone line or radio frequency transceiver.

A memory 810 stores a program 820 for controlling the processor 805. The processor 805 performs instructions of the program 820, and thereby operates in accordance with the invention, and particularly in accordance with the methods described in detail herein. The program 820, as well as any other program for controlling a processor described herein, may be stored in a compressed, uncompiled and/or encrypted format. The following description of program 820 applies equally to all programs for directing a processor described herein. The program 820 furthermore includes program elements that may be necessary, such as an operating system, a database management system and “device drivers” for allowing the processor 805 to interface with computer peripheral devices. Appropriate program elements are known to those skilled in the art, and need not be described in detail herein.

According to an embodiment, the instructions of the program 820 may be read into a main memory from another computer-readable medium, such as from a ROM to RAM. Execution of sequences of the instructions in program 820 may cause processor 805 to perform one or more process steps described herein. In alternate embodiments, hard-wired circuitry may be used in place of, or in combination with, software instructions for implementation of the processes of the invention. Thus, embodiments described herein are not limited to any specific combination of hardware and software.

The memory 810 may also store one or more databases. In one or more exemplary embodiments, as described, data may be stored in a memory of another device (e.g., a database of controller 200 or a database of another server device). In one or more exemplary embodiments, handheld device 106 may be operable to access the data thereof or have information associated with the data stored therein downloaded to the handheld device 106 as necessary and/or appropriate.

In one embodiment, memory 810 may store a database of events or actions on the part of the user that may trigger the handheld device 106 to request location information.

The display device 835 may comprise, for example, one or more distinct display areas and/or one or more distinct display devices 835. For example, one of the display areas may display a graphic representation of location information, such as in the form of a map. Yet another of the display areas may display textual directions.

The processor 805 is also in communication with an input device 840, which is a device that is capable of receiving an input (e.g., from a user, a player, or another device) and which may be a component of handheld device 106. An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RHO) receiver, an RF receiver, a thermometer, a pressure sensor, an infrared port (e.g., for receiving communications from another device such as a smart card or PDA of a player), and a weight scale.

In some exemplary embodiments, a handheld device 106 may comprise components capable of facilitating both input and output functions (i.e., input/output devices). In one example, a touch-sensitive display screen comprises an input/output device (e.g., the device outputs graphics and receives selections from users).

Of course, as would be understood by one of ordinary skill in the art, a handheld device 106 may comprise various combinations of any or all of the component devices described herein. For example, in one or more embodiments, the handheld device 106 may include more than one display device 835, one or more other output devices, several input devices 840, and so on.

In a specific example, a handheld device 106 may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. Forms of memory 810 that may be found in a handheld device 106 include, but are not limited to, electronically erasable programmable read-only memory (EEPROM), erasable programmable read-only memory (EPROM) and flash memory. Thus, in one or more embodiments, an EPROM storing software with instructions for carrying out aspects of the various embodiments (as well as instructions for carrying out other functions traditionally performed by the handheld device 106) may replace an EPROM previously installed in a gaming device or may be reprogrammed in accordance with one or more embodiments described herein, such that the handheld device 106 may be configured to operate in accordance with various processes described herein (e.g., requesting location information).

In exemplary and non-limiting embodiment, the display device 835 and input device 840 may operate, together or separately, as a player/user interface. A player/user interface may comprise, for example, a video screen that is a touch screen operable to display maps and directions on the display device 835.

It should be appreciated that one or more embodiments may include storing graphic and/or sound elements that are used to construct the menu of available options. These elements may be stored, for example, in EEPROM, flash memory, hard disk, CD ROM, or in any other suitable storage device. The menu may be displayed via any suitable display device 835, such as a CRT, LCD, VFC, LED display. In one embodiment, the menu may be implemented using only dedicated electromechanical switches. In one embodiment, a player operates an input device 840 of the handheld device 106 operable to display the menu, in order to cause the menu to be displayed. In one embodiment, the device includes a touch screen and a touch screen controller (not shown) associated with a video monitor display device 835. The touch screen and touch screen controller may be operable to communicate with a video controller of the video monitor display device and a processor (e.g., a processor of handheld device 106). Thus, a player may be enabled to indicate decisions by touching the touch screen in the appropriate places.

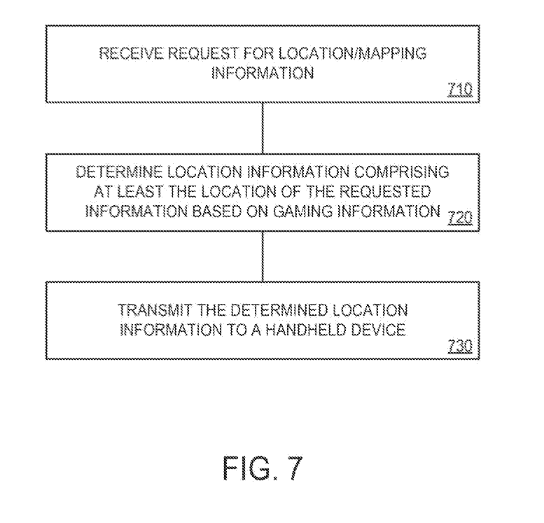

With reference to FIG. 7 there is illustrated a flowchart of an exemplary method according to one or more embodiments.

At step 710, a request for location/mapping information is received.

In accordance with an exemplary embodiment, a user of a handheld device 106 may request position data to be displayed on a map, or to be output in the form of directions on the handheld device 106. The handheld device 106 may be a mobile gaming device 102 that is provided by the casino for the purposes of gambling. Such handheld devices 106 may access software that allows the handheld device 106 to communicate with a server, such as controller 200, having access to location and geospatial information.

In accordance with another exemplary embodiment, a handheld device 106 may be a personal device owned by a player or a casino employee such as a POA, a cell phone, a GPS device, a laptop computer, etc. Such devices may be able to communicate with the controller 200 in order to request information. In some embodiments, the handheld device 106 may request information from the controller 200 via a website on the internet. In such an instance, the user of a handheld device 106 connects to the controller 200 via an internet connection, and is able to utilize the interactive mapping service facilitated by the controller 200 via the website. Handheld devices 106 may be small computing devices such PDA's that are solely dedicated to providing the user with position information. These devices may be made available by a casino for free, for a rental fee, or for purchase.

In some exemplary embodiments, mapping information may be made available to users in response to requests originating from gaming devices 102 as well as kiosks, casino computers, and the like. All such devices may be connected to a controller 200 using a wireless connection or wired connection using e.g., an Ethernet cable. For example, casinos may have mapping kiosks located throughout the floor, or existing kiosks may be connected to a controller 200 and available to provide mapping information. Receptionist computers located at the front desk of a casino/resort may be equipped with mapping capability and may be in communication with controller 200 so as to request location information. In yet another example, players may be able to request and receive mapping information on a display device located at a “smart gaming table”. Smart gaming tables are table games with the capability of receiving/displaying input and output as well as the capability to process electronic data. Smart gaming tables may utilize display devices or other table game input/output interfaces (e.g., touch-sensitive screens, CRT screens, LCD screens, keypads, etc.) embedded within and/or otherwise associated with a table game for the purposes of (i) outputting information to players and/or dealers (e.g., game and outcome information, wagering and payout information, mapping and location information, etc) and/or (ii) receiving input from players and/or dealers (e.g., using a touch-sensitive screen to place wagers, indicate gaming options, request location information, etc.).

As is evident from the above described embodiments, a user of a handheld device 106 may request location information. The user/player may do so by using one or more input devices 340, 840 forming a part of, for example, a gaming device 102 or handheld device 106. Examples of such input devices include, but are not limited to, a touch screen, a keyboard, a microphone, a keypad, a mouse, a trackball, a push button, and the like.

The following exemplary position/mapping requests are indicative of the types of queries that may be sent to and received by the controller 200. For example, a user may request position and/or location information associated with a person within a casino. Position information describes where in the casino a person or object is located. Such information can be output in the form of a location on a map, or a textual description of a location (e.g., inside the poker room, at the blackjack tables next to the Tiki Bar, in the Steakhouse Restaurant, slot machine bank 103) as described more fully below. In an exemplary and non-limiting embodiment, the user may interact with a graphical user interface (GUI) to request information. For example, a handheld device 106 may include a touch screen display, or a display connected to a variety of input devices 840 discussed above.

In some embodiments, a user may use a search tool to find another player. For example, a player who knows that his friend is playing slots somewhere on the casino floor may input that player's name into a search tool on the handheld device 106. Similarly, a player who knows his friend is playing blackjack somewhere may input his friend's player card number into a search tool on the handheld device 106.

In one exemplary embodiment, a plurality of players may be registered as part of a group as indicated, for example, by an entry in the group column 316 of the player database 225. In such an embodiment, each player wishing to be associated in a group of players may pre-register a group or buddy list in a database accessible by the controller 200. Having so registered, a user of the handheld device 106 selects a “Find People” option on the handheld device 106. When such requested information is transmitted to and displayed on the handheld device 106, the output may appear as a display showing a current location of a player determined by the controller 200 perhaps as the result of real-time triangulation via wireless network protocol such as WiFi or based upon data extracted from memory 215. In such a scenario, one or both of the requesting entity (e.g., the user of the handheld device 106) and the location of the requested information may be displayed as an icon/circle/graphical element transposed over a casino map.

In one exemplary embodiment, a request for location or mapping information may not be manually input by a player or user of a device 102, 106. For instance, if Player A registers Player B as a buddy on his handheld device 106, then Player A's device may continually (or periodically or upon a change of location or other event) output location information related to Player B.

In another exemplary and non-limiting embodiment, a user of a handheld device 106 may request the position of a gaming activity such as might take place at a gaming device 102 or gaming table. For instance, a handheld device 106 may have a button labeled “Find a Gaming Activity” (this includes finding a stationary gaming device 102 such as a slot machine or video poker machine, another handheld device 106 or a table game). In another exemplary embodiment, the user of the handheld device 106 may additionally request information associated with the requested gaming activity including, but not limited to, a type of game, max/min bets, a location of game, distance from the user, directions to the game, a status of the game, recent results, a summarized gaming history, a percentage of all recent outcomes that were wins, recent high payouts, payback percentage (e.g., in last x hours), recent players, specifically identified players (e.g. celebrities, friends, etc.), and types of players that have played the game based upon observable or previously stored demographic data.

In another exemplary embodiment, a user of a handheld device 106 may search for a particular gaming device such as a free table game or traditional gaming device (slot machine, video poker machine). For example, the user may instruct the handheld device 106 to notify him (including directions/maps) when a free $5 blackjack table opens. In response, the handheld device 106 may periodically or substantially continuously query or poll controller 200 to determine such availability. Alternatively, the handheld device 106 may register the user's request with the controller 200, which may “push” an availability message to the user's device once a table becomes available. In such an instance, the user of the handheld device 106 may subsequently communicate with the controller 200 to confirm a reservation of an available gaming activity such as, for example, for a predefined period of time.

In an exemplary embodiment, in addition to requesting location information of a gaming activity or device, a user may use a handheld gaming device 106 to reserve a spot at a Blackjack table (or any other table game), so long as he agrees to play a certain amount of hands and/or wager a certain amount at the table. A user may be required to “penalty secure” the reservation by tendering a credit card or otherwise authorize or agree to the charging of an account should the user not gamble at the table as agreed.

When a user of a handheld device 106 makes a request for location information, the request is sent to the controller 200, With reference to step 720, the controller 200 proceeds to determine a response to the request based on information that is stored, for example, in memory 215. The request provides the controller 200 with identification information sufficient to allow for the retrieval of desired data from, for example, player database 225, gaming activity database 230, and geospatial database 235.

In some exemplary embodiments, the position of a player or gaming device/gaming activity is determined based on information that is normally collected by a gaming machine and possibly sent to a casino's controller 200. By using this type of information, casinos may alleviate or avoid the need for new hardware purchases. In other words, position and location information is determined with reference to a casino's existing player tracking infrastructure instead of implementing new tracking hardware such as Wi-Fi tracking tags. For example, Player A is currently playing slot machine as evidenced by the insertion of a tracking card, Player A's identification information and the position of the gaming device 102 being utilized may then be sent to a controller 200 and can then be stored in an appropriate database or databases in memory 215. When a handheld device 106 requests the location of Player A, the controller searches the appropriate database for Player A's identification information and retrieves the location information of the gaming device 102 at which Player A is currently playing.

In another exemplary embodiment, a player swipes tracking card and/or an RFID badge recognized at restaurant. For instance, Player B is at the Casino Steakhouse Restaurant and uses his player tracking card to receive a complimentary meal. When his card information is input into the POS, this information is sent to the controller 200 and stored in a database. When a handheld device 106 requests the location of Player B, the controller searches the database/databases for Player B's identification information and retrieves the location information of the POS terminal in the restaurant.

In another exemplary embodiment, a player C has purchased tickets to a concert at the casino, and presented his player card during the purchase. This information is sent to and stored by the controller 200. During the concert, any device that requests Player C's position will receive the response that Player C is watching a concert.

In another exemplary embodiment, a dealer swipes Player D's player card at a poker table, and this information is sent to the controller 200. When a device, such as a handheld device 200, requests Player D's location, the controller 200 searches the database for Player D's information and retrieves the location information of the poker table.

In other exemplary embodiments, a player's position can be determined based on the position of a mobile gaming device 102, a casino mapping device, or another mobile/handheld device 106 that is (i) owned by the user (e.g., a personal cell phone or PDA) and registered with the controller 200 or (ii) owned by the casino and distributed to the user/player (e.g., a casino worker's mobile mapping device, a player renting a handheld device 106 from the casino).

In another exemplary embodiment, the user of a handheld device 106 may be prompted to input where the player is inside the casino with the inputted data being sent to the controller 200 and stored for later access. For example, when a player is sitting at a blackjack table, he or she may enter the table number into a handheld device 106. Similarly, the user of a handheld device 106 may input the name of the gaming device 102 he or she is playing, the game's serial number, the machine bank number, or the like. In another exemplary embodiment, the handheld device 106 may be outfitted with a wireless transmitter such as an RHO tag or a Wi-Fi tag that allows the controller 200 to track where the player is within the casino. In other embodiments, triangulation calculations may be used to estimate a handheld device's 106 location. In such an exemplary embodiment, extra sensors may or may not need to be mounted within the casino consistent with known methods of determining indoor position such as that described in Comparison of Wireless Indoor Positioning Technologies, written and published by Ekahau Inc. of Saratoga, Calif. In addition, a handheld device 106 may comprise an accelerometer and/or a gyroscope which detects movement and orientation of the handheld device 106. In such instances, position information acquired by or inputted into the handheld device 106 is communicated to controller 200 for later access.

As noted above, in various exemplary embodiments, the location of stationary devices or gaming tables may be requested. For instance, a player or user of a handheld device 106 may request the location of a casino's blackjack tables. Since it is rare for a casino to move its blackjack tables, the location may be stored permanently in a database, such as geospatial database 235, accessible by the controller 200, Thus, whenever a player or user searches for gaming activities comprising blackjack tables, the position of each blackjack table does not have to be dynamically determined. The position of other stationary objects may be stored permanently as well, such as slot machines, other table games, restaurants and bars, entertainment venues, stores, bathrooms, and the like.

In the event that a stationary object is moved, its position may be manually updated in a database accessible by the controller 200. In some exemplary embodiments, players and users may request the location of a stationary object based on a dynamic factor. For example, a player may ask the location of the nearest poker table, or the location of an “open” video poker machine. This information may need to be taken into account when determining the location of stationary objects. As noted above, the status of a gaming activity, such as a video poker machine or a blackjack table, may be recorded in and subsequently accessed from, for example, gaming activity database 230. For example, when a blackjack table is full, the blackjack table's entry in the gaming activity database 230 may indicate that the blackjack table is “In use”. If the location of an “available” blackjack table is requested, the controller 200 will not include “In use” tables in a response to such a request. In a further example, a player or user may request the location of the nearest ALIENS® slot machine. Controller 200 may then respond by a finding all ALIENS® slot machines, determining which is the closest to the user, and transmitting location information comprising only that response. As is evident, the exemplary embodiments described above are broadly drawn to encompass any and all requests for location information that may be expressed as Boolean search criteria wherein the search may be performed on any and all data stored in memory 215, derived from data stored in memory 215, or otherwise available to controller 200.

In an exemplary embodiment, a request for location data comprises a request for directions to the requested destination. In such embodiments, the controller (i) determines the location of the requested destination, (ii) determines the location of the requestor or requesting handheld device 106, and (iii) refers to stored casino layout information, such as is stored in geospatial database 235, in order to configure instructions on how to navigate from the requestor to the requested destination. In such an instance, the controller may use any of the above described exemplary embodiments in order to determine the location of a requested destination.

Likewise, the controller 200 may utilize any and all of the aforementioned methods to determine the location of the requestor. Because the requestor is using a device, such as a handheld device 106, that is in communication with the controller 200, the controller 200 may be able to determine the requestor's location based on one of the described methods.

In an exemplary embodiment, the controller 200 may determine a shortest route between the requestor and determined destination. In one exemplary embodiment, the controller may account for heavy “foot traffic” due to the time of day or the recent ending of a show, and offer alternate routes in order to avoid large crowds. Other location information that may be determined by the controller 200 in response to a request includes, but is not limited to, automated suggestions and other dynamic Mapping/Direction Navigation Features and Services. For example, directions may be configured such that the requester is directed near casino products/services in which he or she may be interested. Such directions may be determined based on, for example, the amount of money spent by the player (through the device or otherwise) on goods or services, or how much they've won/lost gambling through a handheld device 106 or at a gaming device 102.

In another exemplary embodiment, the controller 200 may determine additional location information comprising routing information based upon an estimated time to get to a destination. As a result, destination options may be determined and/or sorted based on distance between requesting handheld device 106 and one or more determined destinations. Similarly, destination options may be determined and/or sorted based on an estimated time for a requester to get from a handheld device's 106 current location to a determined destination (e.g. based on actual travel paths rather than sheer distance; based on the requester's average pace as determined through GPS or RFID tracking of the handheld device 106 as it moves throughout a casino's property).

Once a player is using a handheld device 106 for navigational purposes, such as by following directions or a map, the handheld device 106 may cause an output if it is determined by the handheld device 106 and/or a computer associated therewith, such as the controller 200, that the operator of the handheld device 106 veers off the path required to get to the destination. For example, a handheld device 106 may beep, vibrate, cause an output on its LCD screen, etc.

In an exemplary embodiment, a player may voluntarily cause a map, directions or other location information to be sent to one or more individuals such as individuals registered in the player's group as, for example, in player database 225. For example, a first player in a social “gambling group” (e.g. of friends) may press a button on his handheld device 106 to cause a set of “Find me here” directions to be sent to his “gambling group”. The first player's handheld device 106 and/or the controller 200 may determine each additional group member's location (e.g. perhaps as a function of the location of each additional group member's handheld device 106 or presence at a given slot machine) and then determine directions from the first player's handheld device 106 to each additional group member (e.g., to each additional group member's handheld device 106).

Lastly, at step 730, the determined location information is transmitted to the handheld device 106. In an exemplary embodiment, the controller transmits the previously requested and determined location information to the handheld device 106.

Once the location information has been received, the information may be output using a variety of methods. In some exemplary embodiments, the presentation method may be dictated by the format of a request. For example, if the request was an inquiry as to the location of a player, then the received location information may be presented as a location of the player on a map. Similarly, if the request is for directions to the player, then the received location information may be presented as textual directions.

In some exemplary embodiments, the controller 200 may operate to obtain authorization from a player or person to output a requested location. For example, if player A requests the location of player B, before the location of player B is output to player A, player B may be required to authorize or re-confirm authorization of this release of the information. Such authorization may form a requirement associated with, or separate from, the inclusion of each player in a predetermined group. In an exemplary embodiment, such authorization or permission may form an entry in a player database, such as player database 225, that may be dynamically configured, such as by a player associated with the entry.

In exemplary embodiments, the requester may specify, or may be prompted to specify the output method. For example, a pop up box displayed on the display device 835 of the handheld device 106 asks “Would you like directions to Bob?” In other exemplary embodiments, the location information may be output as a set of textual directions. For example, text may be used to describe an easiest path (e.g., “Turn left at the bank of Big Texas Knockout machines: or “walk towards the Cashier station, turn left and walk towards the first bank of slot machines on your right. The requested machine is machine # 122”).

In an exemplary embodiment, the location information may be output as a graphic display. For example, the requested location may be highlighted on a map of the casino floor, graphics of roulette wheels mark every roulette table on a virtual overhead map, or the location of the user's friends are marked by colored dots overlaid onto a virtual overhead map. In yet another exemplary embodiment, the requested location information may be output as a picture or video of a location. For example, an overhead view of a section of the casino floor is shown such that the user is able to see useful landmarks like a restaurant or the main entrance in the background.

In another exemplary embodiment, location information comprising directions and/or locations may be output using audio. Examples include, but are not limited to, a speaker forming part of the handheld device 106 outputting an audio signal such as “Bob is playing poker in the poker room”, “the requested machine is located directly in front of the stairway located 20 yards to your left”, “blackjack table 122 has 3 spots open”, or “turn left,” “walk straight” and “turn right”.

In another exemplary embodiment, directions may be output as a graphical display on the output device 835 of a handheld device 106. For example, arrows, dots, lines, and other markings may be overlaid onto a map to help the user navigate to a specified location. The user's location may be marked on a map with a line drawn from the user to a requested location. In addition, maps and directions may be modified based on the user's location. For example, the map on the display device 835 may be output such that it matches the user's orientation. Similarly, the map on the display device 835 may be only an area where the user and a determined location are (instead of outputting the entire casino map).

In an exemplary embodiment wherein the handheld device 106 includes digital camera functionality, a real-time image of information by the handheld device 106 may be rendered on an LCD screen of the handheld device 106, and the handheld device 106 may superimpose or otherwise “overlay” directional queues for the requester on the real-time image.

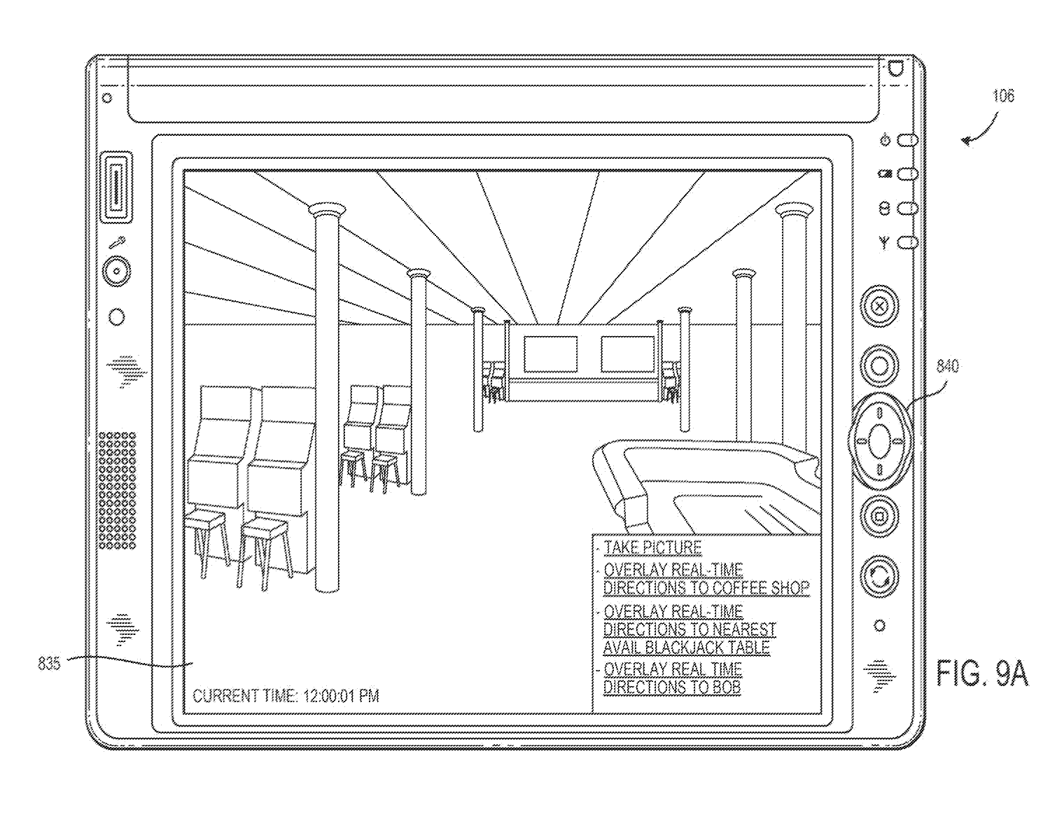

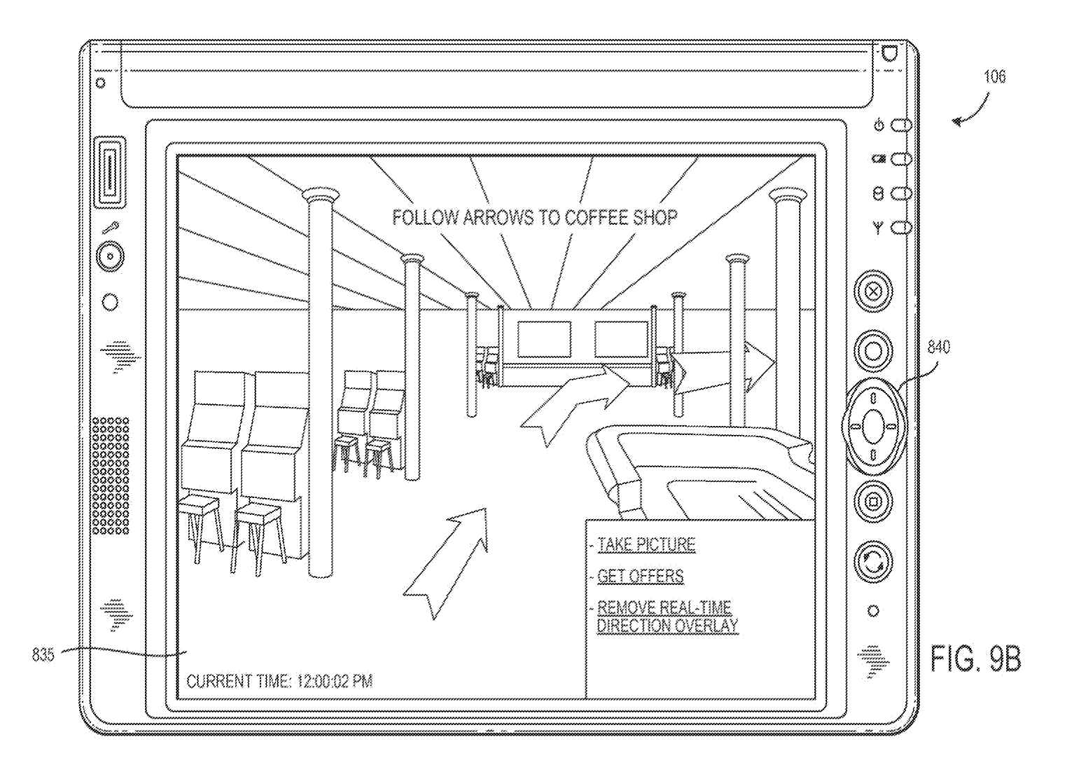

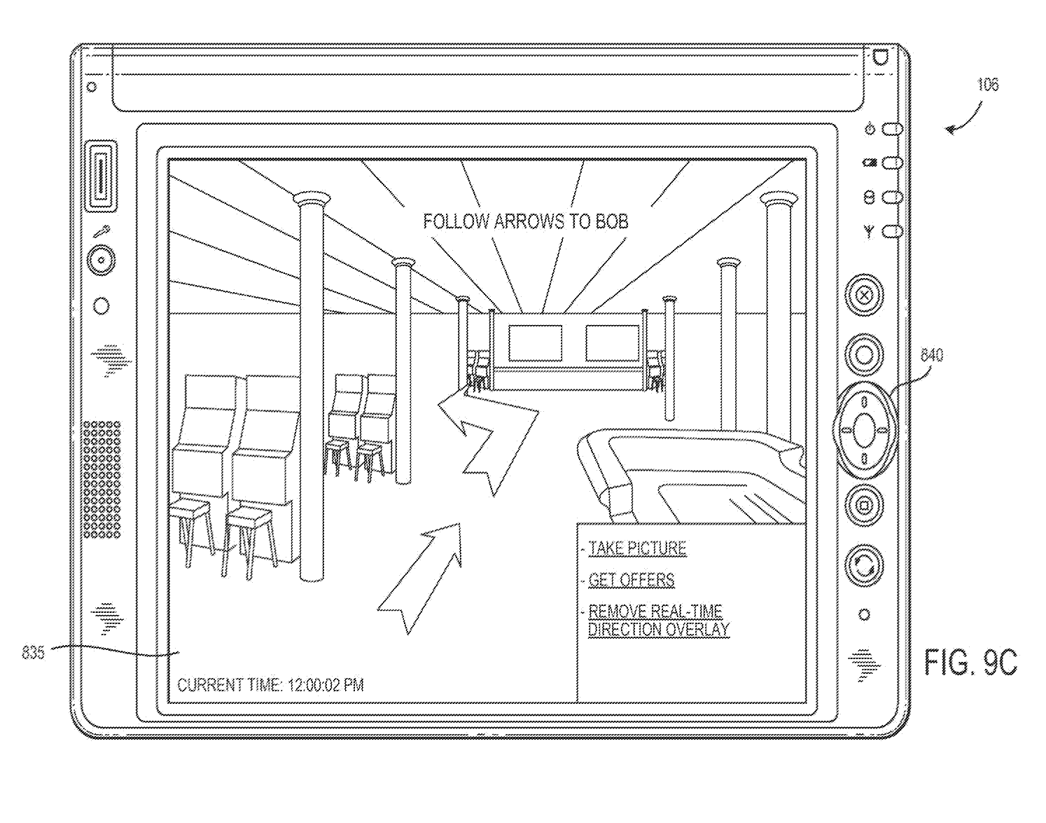

With reference to FIG. 9A, there is illustrated an image output on an LCD touch screen forming a display device 835 of a handheld device 106 wherein the image depicts the real-time input received by the handheld device's camera. In the example shown, a variety of menu options are available for the player's selection on the LCD touch screen, including (a) “Take Picture”, (b) “Overlay Real-Time Directions to Coffee Shop”, (c) “Overlay Real-Time Directions to Nearest Available Blackjack Table”, and (d) “Overlay Real-Time Directions to Bob.”

If the player selects “Overlay Real-Time Directions to Coffee Shop” (e.g. by touching the corresponding text on the LCD touch screen), the handheld device 106 may overlay or superimpose arrows, lines, stars and/or other directional queues on the image so that the player may readily see the path he must walk to get to the Coffee Shop.

An example of superimposed arrows is provided with reference to FIG. 9B. For the purposes of the present example, it has been determined by the handheld device 106 and/or by a computer in association therewith that the user of the handheld device 106 is registered as a friend or relative of one “Bob” (e.g., because the player's identity is linked to Bob's player id in the player database 225. If the player selects “Overlay Real-Time Directions to Bob,” the handheld device 106 and/or a computer associated therewith may determine Bob's location (e.g. perhaps as a function of the location of Bob's handheld gaming device 106) and then determine directions from the player's handheld device to Bob (or to Bob's handheld gaming device 106).

With reference to 9C there is illustrated what a user of a handheld device 106 may see if he selected “Overlay Real-Time Directions to Bob” in lieu of selecting the alternative options available through the menu on the screen of FIG. 9A.

The handheld device 106 may provide “real time directional overlays” by first determining the positioning and/or orientation of the handheld device 106 relative to a selected target destination and then superimposing arrows (or any other visual indicators) to show the appropriate general path to the target (e.g., selected) destination location. The handheld device 106 and/or a computer associated therewith (e.g. controller 200) may determine the handheld device's 106 orientation relative to a target destination through any one of a variety of means and methods, including but not limited to GPS data analysis, RFD triangulation, cellular triangulation, and/or image analysis.

The handheld device 106 and/or a computer in connection thereto, such as controller 200, may further analyze the image to determine the fastest or substantially fastest travel path by accounting for apparent physical obstacles (e.g., slot machines on the floor; high traffic areas). Suitable automated image recognition software is commercially available from a variety of providers and may be configured to assist in obstacle identification. Once an appropriate path is determined, arrows or other indicators may be superimposed on the real-time image that is output on the handheld device's 106 display device 835.

In another exemplary embodiment, a human operating a remote computer, such as controller 200, may “draw” directional overlay information on an image received from a player's handheld device 106 and cause the transmission of the overlay information and/or edited image back to the player's handheld device 106 so that the player may view the image with the benefit of the directional overlay information (arrows, etc.).

Note that as the operator of the handheld device 106 proceeds to walk to the displayed destination while carrying the handheld device 106, the handheld device's 106 physical position and orientation will necessarily change, requiring the handheld device's 106 processor 805 to update or adjust the directional overlay information. Such updating or readjustment may be triggered: automatically (e.g. periodically, such as every 5 seconds), upon request of the user (e.g. a “refresh” button), upon receipt of a new camera image or an image which is markedly different from a previous image, and/or upon detection of movement of the handheld device 106. For example, a motion/kinetic sensor may detect movement of the handheld device 106 or a central computer in communication with an RFID-enabled handheld device 106 may determine that the handheld device 106 has moved on a property-wide RFID sensor grid.

In an exemplary embodiment, the controller 200, sensing the location of user of a handheld device 106, may utilize the display devices 335 of a gaming device 102 situated or otherwise located along the user's path to dynamically create a “trail” of arrows, lights or other trail indicators for the user to follow. For example, as the user approaches an area in which he is supposed to make a right turn, an unoccupied slot machine's 102 display 335 (the slot machine being located where the user is supposed to turn) is directed to display a right turn arrow as the user is approaching it, then directed to go back to “attract mode” once the user passes.

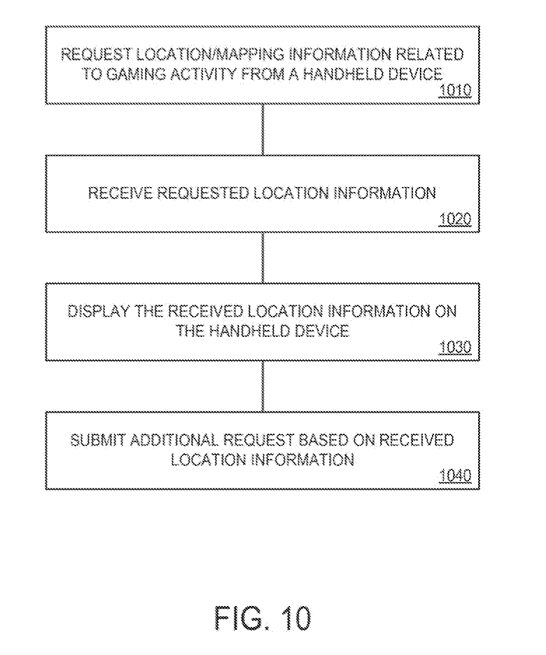

With reference to FIG. 10 there is illustrated a flowchart of an exemplary method according to one or more of the preceding exemplary embodiments as realized from the perspective of a user of a handheld device 106. At step 1010, a request for location information related to gaming activity is made, such as, for example, via a handheld device 106 in communication with controller 200. At step, 1020, a reply to the request is received from, for example, controller 200. At step 1030, the received location information is displayed on the handheld device 106. Optionally, at step 1040, the user of the handheld device 1040 may request additional information based upon the received location information.

In another exemplary and non-limiting embodiment, players may be able to facilitate communication with a player or destination using the system 100. For example, one a user of a handheld device locates a player, such as fellow member of a predefined group, the system 100 may facilitate or otherwise enable communication with the selected group member. In some exemplary embodiments, input/output devices 840, 835 of a handheld device 106 may be used to facilitate verbal communication or a peripheral device may be used in conjunction with a handheld device 106 to facilitate verbal communication.

The invention is claimed as follows:

1. A device operable to facilitate wagering activity, comprising:
a processor;
a memory operable to communicate with the processor, the memory storing instructions for directing the processor to perform a method, the method comprising:
receiving a request for a location of a gaming activity from a handheld device;
determining at least one location of the gaming activity based upon gaming information; and
transmitting location information comprising the at least one determined location of the gaming activity to the handheld device.

2. The device of claim 1 wherein the method further comprises receiving a selection of a gaming activity associated with at least one determined location and transmitting information associated with the selected gaming activity.

3. The device of claim 2 wherein the information comprises at least one of a type of gaming activity, a location of the gaming activity, a status of the gaming activity and a distance of the gaming activity from the handheld device.

4. The device of claim 2 wherein the information comprises at least one of previous results of the gaming activity, a summary of the gaming history of the gaming activity, recent payouts of the gaming activity, and prior participants in the gaming activity.

5. The device of claim 1 wherein the method further comprises receiving a request to reserve participation in the gaming activity at the at least one determined location.

6. The device of claim 5 wherein the method further comprises transmitting a confirmation of a reservation made in response to receiving the request to reserve.

7. The device of claim 6 wherein the reservation is made in response to a receipt of consideration.

8. The device of claim 7 wherein the request comprises a period of time to hold a reservation.

9. A computer readable medium storing instructions configured to direct a processor to perform a method comprising:
receiving a request for a location of a gaming activity from a handheld device;
determining at least one location of the gaming activity based upon gaming information; and
transmitting location information comprising the at least one determined location of the gaming activity to the handheld device.

10. A device operable to facilitate wagering activity, comprising:
a processor;
a memory operable to communicate with the processor, the memory storing instructions for directing the processor to perform a method, the method comprising:
determining at least one of a product and a service based upon a gaming activity of a player;
determining at least one location of the at least one of a product and service; and
transmitting information comprising the determined at least one location of the at least one of a product and service to the player.

11. The device of claim 10 wherein the gaming activity comprises at a one of an amount won by the player and an amount lost by the player.

12. The deice of claim 10 wherein the information is transmitted to a handheld device.

13. The device of claim 10 wherein the information is sorted based upon a distance from the player to the at least one product and service.

14. A computer readable medium storing instructions configured to direct a processor to perform a method comprising:
determining at least one of a product and a service based upon a gaming activity of a player;
determining at least one location of the at least one of a product and service; and
transmitting information comprising the determined at least one location of the at least one of a product and service to the player.
